(19) United States
(12) Patent Application Publication
(10) Pub. No.: US 2013/0216850 A1
(43) Pub. Date: Aug. 22, 2013

(54) STRUCTURAL COMPONENT FOR AN AIRCRAFT OR SPACECRAFT

(71) Applicant: Airbus Operations GmbH, (US)

(72) Inventors: Alexei Vichniakov, Buxtehude (DE); Johannes Maslennikov, Buxtehude (DE); Robert Alexander Goehlich, Hamburg (DE); Cihangir Sayilgan, Hamburg (DE)

(73) Assignee: AIRBUS OPERATIONS GMBH, Hamburg (DE)

(21) Appl. No.: 13/770,080

(22) Filed: Feb. 19, 2013

Related U.S. Application Data
(60) Provisional application No. 61/599,968, filed on Feb. 17, 2012.

(30) Foreign Application Priority Data
Feb. 17, 2012 (DE) 10 2012 202 504.9

(51) Int. Cl. B64C 1/06

(52) U.S. Cl. CPC B64C 1/064
USPC 428/573; 428/174

(57) ABSTRACT

A structural component for an aircraft or spacecraft having an outer skin, comprising at least one former element for reinforcing the outer skin. The former element is arcuately curved in accordance with an inner contour of the outer skin 10, wherein the former element has a plurality of first cutouts for receiving longitudinal reinforcements and at least one second cutout, which is configured between adjacent first cutouts of one or more former elements. The invention furthermore relates to an aircraft or spacecraft with the structural component according to the invention.

### CROSS-REFERENCES TO RELATED APPLICATIONS

This application claims benefit of the U.S. Provisional Application No. 61/599,968, filed Feb. 17, 2012, and of the German patent application No. 10 2012 202 504.9, filed Feb. 17, 2012, the entire disclosures of which are incorporated herein by way of reference.

### FIELF OF THE INVENTION

The present invention relates to a structural component for an aircraft or spacecraft, and in particular a structural component, which has a former element. Furthermore, the invention relates to an aircraft or spacecraft with a structural component of this type.

Although they can be applied to any desired light structures with a reinforced outer skin, the present invention and the problems on which it is based will be described in more detail in relation to the inside of an aircraft fuselage.

### BACKGROUND OF THE INVENTION

Fuselage shells for aircraft are generally produced in a so-called light construction mode from an outer skin, which is reinforced on the inside by a structure made of stringers or longitudinal reinforcements running in the longitudinal direction of the aircraft and formers running transverse to the longitudinal direction of the aircraft as reinforcement elements. Components and structures connected with the utilisation of the aircraft, such as, for example, hold floors or passenger cabin floors, are fastened to the formers in the interior of the aircraft fuselage.

Furthermore, the fuselage diameter is determined by aerodynamic requirements, on the one hand, and a space requirement for passengers, on the other hand. Available space for structural, system and cabin elements is severely limited. This volume can only be slightly utilised, as a main proportion of routes or lines is arranged in the flight direction and undercuts between the formers are hardly utilised.

The system architecture is made more difficult by segregation specifications and the small amount of available space. Moreover, minimum spacings from the structure have to be adhered to. The routes are received at intervals by holders. Primary holder positions have to be changed in the case of optional or customer-specific systems. These holders have to be measured and manually positioned. Cabin elements are introduced after a system installation.

These factors lead to an architecture similar to an onion skin model, the structural elements, system equipment and cabin integration being the individual skins.

The installation has to primarily take place part by part. This leads to a poor utilisation of space. Furthermore, customer-specific adaptation of the primary structure is prone to faults and this can lead to increased manufacturing costs.

### SUMMARY OF THE INVENTION

Against this background, one idea of the present invention is to provide an improved structural component for an aircraft or spacecraft, which allows better utilisation of space and easier adaptation of the primary structure.

The invention provides a structural component for an aircraft or spacecraft with an outer skin, with at least one former element for reinforcing the outer skin, which is arcuately curved in accordance with an inner contour of the outer skin. The former element has a plurality of first cutouts to receive longitudinal reinforcements and at least one second cutout, which is configured between adjacent first cutouts of one or more former elements.

The provision of the at least one second cutout between adjacent first cutouts of the former element allows an improved utilisation of space, as the at least one second cutout can be utilised to guide through or hold routes.

Furthermore, the provision of second cutouts results in a reduction in the weight of the aircraft. In addition, an improved accessibility of the former elements can be achieved. As a result, for example, when a plurality of former elements is provided, necessary former couplings can be fastened to the respective second cutouts and a simple assembly is thereby achieved. Likewise, the system installation can be facilitated by the improved accessibility of the former elements. The plurality of second cutouts may, for example, be used to install holders without the provision of additional bores of the former element. In addition, the possibility is produced of using click-in or similar principles for holders. Moreover, a reduction can be achieved in activities that do not add value during assembly such as, for example, omitting measurements for bores of holders for holding routes. Furthermore, the possibility is produced of a visual control of installed rivets.

It is preferably provided that the second cutout is, in each case, configured as an opening in opposing side walls of the former element. This allows a facilitated accessibility of the former element.

It is advantageously provided that the opening in the opposing side walls is, in each case, arranged at the same position. The second cutout is therefore also suitable for holding the cable or hydraulic lines, so separate holders do not have to be provided. Furthermore, easy guiding of cable or hydraulic lines through the second cutouts configured in opposing side walls of the former element is made possible.

It is advantageously provided that the opening in the opposing side walls is in each case arranged at different positions. Thus, easier accessibility of the inner wall of the side wall opposing the opening can be made possible. According to an advantageous development of the invention, it is provided that the opening in the opposing side walls is configured along a transverse axis of the former element. Because of the laying of the former elements transverse to the flight direction, the routes arranged in the flight direction may be guided linearly and guided through the second cutout of the former element.

According to an advantageous development of the invention it is provided that the former element has an omega-shaped, circular, elliptical, round-cornered or polygonal profile. This allows an adaptation to respective spatial or structural requirements.

According to a further preferred embodiment, it is provided that the second cutout is configured to receive a coupling element for coupling adjacent former elements. Thus, an easy fastening of the coupling element to the former element and a secure connection of adjacent former elements can be achieved by providing the coupling element. The provision of a flange or other connecting elements on the respective former elements to connect adjacent former elements can therefore be dispensed with.

It is preferably provided that the second cutout is configured to guide cable or hydraulic lines along a longitudinal axis of the aircraft or spacecraft through the former element. Therefore, an optimal utilisation of space can be achieved. Moreover, the cable or hydraulic lines can be guided linearly, so branches or bends of the line guidance can be avoided.

The structural component thus serves as a holder for the cable or hydraulic lines, so additional holders do not have to be provided. It is preferably provided that the second cutout is configured to receive holders, metal fittings or other structural connection elements for fastening components such as, in particular, overhead luggage compartments or side wall panels. Because of the improved accessibility of the former element, it can be used to install the above-mentioned components.

According to an advantageous development of the invention, it is provided that the former element is configured from a carbon-fibre-reinforced plastics material, a metal, a metal alloy or a hybrid material. This allows a high material strength and a low weight of the former element.

Furthermore, an aircraft or spacecraft with the structural component according to the invention is advantageously provided.

### BRIEF DESCRIPTION OF THE DRAWINGS

Embodiments of the invention are shown in the drawings and described in more detail in the following description.

In the figures:

FIG. 1 shows a schematic view of a portion of an aircraft fuselage with the structural component according to the invention, according to a preferred embodiment;

FIG. 2 shows a schematic view of the structural component according to the invention, according to the preferred embodiment;

FIG. 3 shows a schematic view of the structural component according to the invention, according to the preferred embodiment; and

FIG. 4 shows a schematic view of a plurality of structural components according to the invention, according to a further preferred embodiment.

In the figures, the same reference numerals designate the same or functionally the same components.

### DETAILED DESCRIPTION OF THE PREFERRED EMBODIMENTS

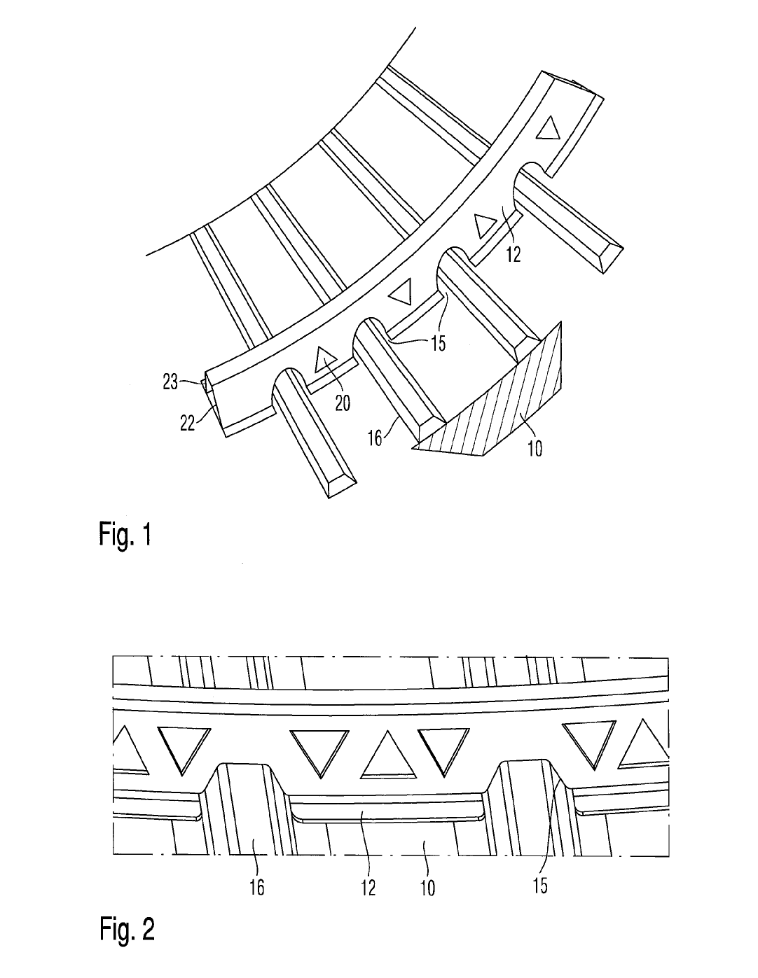

FIG. 1 shows a schematic view of a portion of an aircraft fuselage with the structural component according to the invention. The aircraft fuselage has an outer skin 10, a former element 12 and a plurality of longitudinal reinforcements 16.

The outer skin 10 of the aircraft fuselage is arcuately curved. The former element 12 is installed transverse to the flight direction and also arcuately curved in accordance with an inner contour of the outer skin 10. The former element 12, according to the preferred embodiment, has an omega-shape in one cross-section of the former element 12. The former element 12 may, however, also have any desired other shape such as, for example, a rectangular shape, a rectangular shape with rounded edges, a trapezoidal shape, a trapezoidal shape with rounded edges, a triangular shape and a triangular shape with rounded edges.

The former element 12 furthermore has a first side wall 22 and a second side wall 23, which are connected at their upper ends by a horizontal portion. The side wall 22 moreover has, at a portion adjacent to the outer skin 10, a horizontal extension or a horizontal portion, which can be fastened to the outer skin 10 by a plurality of, for example, rivets. The second side wall 23 also has, at a portion adjacent to the outer skin 10, a horizontal extension or a horizontal portion, which can be fastened to the outer skin by a plurality of rivets.

The former element 12 has a plurality of first cutouts 15 and a plurality of second cutouts 20. The plurality of first cutouts 15 is used to receive longitudinal reinforcements 16. The second cutout 20 is, in each case, arranged between adjacent first cutouts 15 of the former element 12. The plurality of first cutouts 15 is adapted to the contour or shape of the respective longitudinal reinforcements 16.

The second cutout 20, according to the preferred embodiment, has a triangular shape. Alternatively, the second portion 20 may also have any desired other shape such as, for example, a round shape, an oval shape, a rectangular shape, a trapezoidal shape or the like. The second cutout 20 is configured here, in each case, in the side walls 22, 23 of the former element 12. The second cutout 20 is, in particular, arranged in a central region of the side walls 22, 23 and, in each case, in the opposing side walls 22, 23 at the same position. An individual former element 12 is shown according to FIG. 1. The former element 12 has an omega-shaped profile. Alternatively, the structural component may have a circular, elliptical, round-cornered or polygonal profile. Moreover, the structural component may have a plurality of former elements 12, which are arranged adjacent to one another and connected by suitable former couplings. A longitudinal and/or transverse profile of the structural component may be open or closed.

The structural component shown in FIG. 1 is arranged along a longitudinal axis of the aircraft at regular intervals. In the present case, however, only one structural component is shown. By providing a plurality of structural components at regular intervals along the longitudinal axis of the aircraft, the respective structural components can be used as holders for cable or hydraulic lines, not shown, owing to the second cutouts 20 configured in the structural components.

FIG. 2 shows a schematic view of the structural component according to the invention in a perspective side view according to the preferred embodiment. In the present embodiment, a plurality of second cutouts 20 is arranged between adjacent first cutouts 15 of the former element 12. A respective cutout of the plurality of second cutouts 20 has a triangular shape. The orientation of the triangles differs from one another in such a way that respective cutouts 20 arranged adjacent to one another are rotated, in each case, through 180° with respect to their orientation. By providing the plurality of second cutouts 20 between respective adjacent first cutouts 15 of the former element 12, a plurality of cable or hydraulic lines, not shown, can be guided accordingly. The respective cutouts 20 may also have any desired other shape.

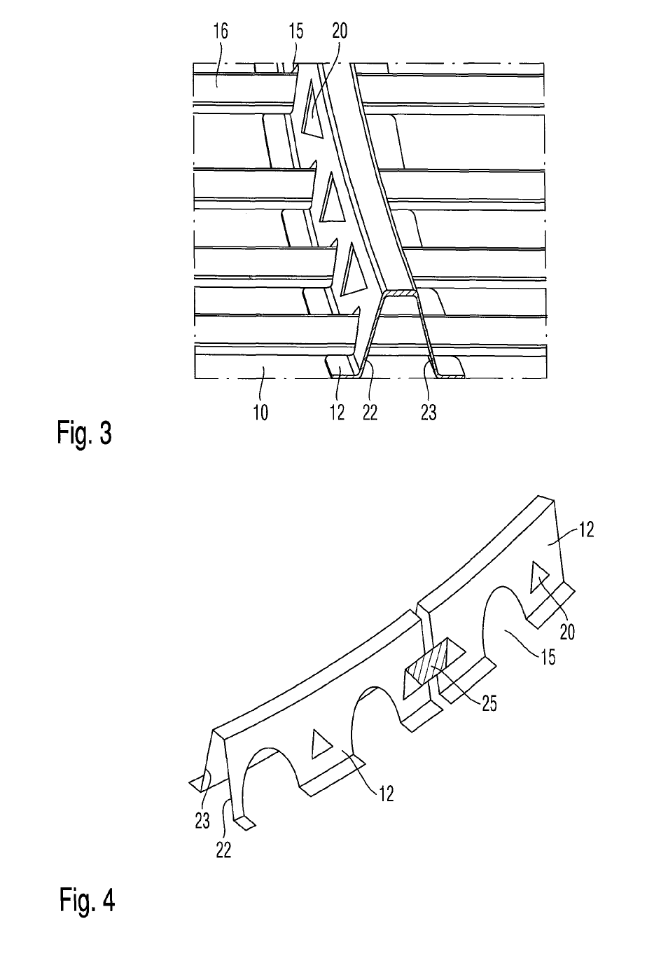

FIG. 3 shows a schematic view of the structural component according to the invention, according to the preferred embodiment. According to the embodiment, a single former element 12 of the structural component is shown. The former element 12 has an omega-shape with two opposing side walls 22, 23. The side walls 22, 23 are in each case provided with an extension or a horizontal portion in the portion adjacent to the outer skin 10. The side walls 22, 23 are furthermore connected to one another at a respective distal portion by a horizontal portion. The former element 12 may, however, also have any desired other shape. Possible other former shapes are, for example, a rectangular shape, a rectangular shape with rounded edges, a trapezoidal shape, a trapezoidal shape with rounded edges, a triangular shape and a triangular shape with rounded edges.

FIG. 4 shows a schematic view of a plurality of former elements 12 of the structural component. The plurality of former elements 12 is connected by a coupling element 25 to couple the adjacent former elements 12. The coupling element 25 is configured in such a way that it is connected to a respective second portion 20 of respective adjacent former elements 12. The coupling mechanism of the coupling element 25 is not shown in more detail here. It may, for example, be a double-L angle, which is arranged on either side of the respective former elements 12, i.e. on respective side walls 22, 23 of the former elements 12. Alternatively, another suitable coupling mechanism can also be provided.

The structural component or former element 12 is configured from a carbon-fibre-reinforced plastics material. This may, for example, comprise so-called prepreg materials, textile materials, thermoplastic materials, titanium materials, Al/Al—Li/Al—Mg—Sc materials.

The former elements 12 may be fastened to the outer skin 10 in various ways. For example, the formers 12 may be riveted on, glued on, welded on or connected using other suitable rivetless methods.

Apart from the use of the present invention in aircraft and spacecraft, an application in space stations, satellites, masts or towers of wind turbines and in automotive and ship construction is also conceivable.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A structural component for an aircraft or spacecraft having an outer skin, comprising:
at least one former element for reinforcing the outer skin, which is arcuately curved in accordance with an inner contour of the outer skin, wherein the former element has a plurality of first cutouts for receiving longitudinal reinforcements and at least one second cutout, which is configured between adjacent first cutouts of one or more former elements.

2. The structural component according to claim 1, wherein the former element comprises opposing side walls and each second cutout is configured as an opening in the opposing side walls of the former element.

3. The structural component according to claim 2, wherein each second cutout opening is arranged at the same position in the opposing side walls.

4. The structural component according to claim 2, wherein each second cutout opening is arranged at different positions in the opposing side walls.

5. The structural component according to claim 2, wherein the opening in the opposing side walls is configured along a transverse axis of the former element.

6. The structural component according to claim 1, wherein the former element has one of an omega-shaped, circular, elliptical, round-cornered and polygonal profile.

7. The structural component according to claim 1, wherein the second cutout is configured to receive a coupling element for coupling adjacent former elements.

8. The structural component according to claim 1, wherein the second cutout is configured to guide cable or hydraulic lines along a longitudinal axis of the aircraft or spacecraft through the former element.

9. The structural component according to claim 1, wherein the second cutout is configured to receive at least one of holders, metal fittings and other structural connection elements to fasten components.

10. The structural component according to claim 9, wherein the components comprise overhead luggage compartments.

11. The structural component according to claim 9, wherein the components comprise side wall panels.

12. The structural component according to claim 1, wherein the former element is configured from one of a carbon-fibre-reinforced plastics material, a metal, a metal alloy and a hybrid material.

13. An aircraft or spacecraft with a structural component according to claim 1.
